(19) United States
(12) Patent Application Publication
(10) Pub. No.: US 2014/0363744 A1
(43) Pub. Date: Dec. 11, 2014

(54) Solid-State Battery and Method for Manufacturing Thereof

(71) Applicant: IMEC VZW, Leuven (BE)

(72) Inventors: Philippe M. Vereecken, Luik (BE); Cedric Huyghebaert, Leuven (BE)

(73) Assignee: IMEC VZW, Leuven (BE)

(21) Appl. No.: 14/295,726

(22) Filed: Jun. 4, 2014

(30) Foreign Application Priority Data
Jun. 11, 2013 (EP) 13171347.1

(51) Int. Cl. H01M 4/13; H01M 10/0525; H01M 10/058; H01M 10/056

(52) U.S. Cl. CPC H01M 4/13; H01M 10/056; H01M 10/0525; H01M 10/058; H01M 2300/0065
USPC 429/306; 429/246; 429/232; 429/320; 429/304; 429/319; 429/322; 423/625; 29/623.5

(57) ABSTRACT

A solid-state battery cell includes an anode, a cathode, and a solid electrolyte matrix. At least the anode or the cathode may include an active electrode material having pores. Further, an inner surface of the pores may be coated with a first surface-ion diffusion enhancement coating. The solid electrolyte matrix may further include an electrically insulating matrix for a solid electrolyte. The electrically insulating matrix may have pores or passages and an inner surface of the pores or the passages may be coated with a second surface-ion diffusion enhancement coating.

### CROSS-REFERENCE TO RELATED APPLICATIONS

This application claims priority to European Patent Application No. 13171347.1 filed on Jun. 11, 2013, the contents of which are hereby incorporated by reference.

### FIELD OF THE DISCLOSURE

The present disclosure relates to solid-state batteries and in particular to thin film solid-state batteries. Further, the present disclosure relates to a surface ion-diffusion enhancement coating for a thin film solid-state battery. Furthermore, the disclosure relates to methods for manufacturing a thin film solid-state battery cell.

### STATE OF THE ART

Solid-state batteries have multiple advantages in comparison with batteries using liquid electrolytes, which need membranes to separate cathode/anode and an impermeable casing to avoid leakage. For example, when using a solid electrolyte the distances between anode and cathode may be shorter, thus allowing a more compact battery configuration and higher ion diffusion rates, and thereby higher power. Additionally, there is no risk for thermal runaway, so there is no need for providing bulky power/safety management and cooling systems. The effective energy density may be higher, as a higher percentage of capacity may be used without penalty on cycle lifetime.

Among the solid-state batteries, thin film batteries and especially thin film lithium batteries are gaining more and more interest. A thin film battery is composed of several electrochemical cells that are connected in series and/or in parallel to provide the required voltage and capacity. Each cell consists of a cathode electrode and an anode electrode separated by an electrolyte, which enables ion transfer between the two electrodes. Once these electrodes are connected externally, the chemical reactions proceed in the electrodes, thereby generating electrons and enabling a current to flow in an external circuit. In rechargeable cells, the reactions at both anode and cathode electrodes need to be highly reversible to maintain the specific charge for hundreds of charge/discharge cycles. Among the various existing technologies, thin film lithium batteries are considered as the most competitive power source because of their high volumetric energy density and gravimetric energy density, superior power capability and design flexibility.

### SUMMARY OF THE DISCLOSURE

In a first aspect, the present disclosure is related to a solid-state battery cell comprising an anode, a cathode and a solid electrolyte matrix, wherein at least one of the anode and the cathode comprises an active electrode material (functional battery material) having pores, wherein an inner surface of the pores is coated with a first surface-ion diffusion enhancement (SIDE) coating; and wherein the solid electrolyte matrix comprises an electrically insulating matrix, the electrically insulating matrix having pores or passages, wherein an inner surface of the pores or the passages is coated with a second surface-ion diffusion enhancement (SIDE) coating. Either the electrically insulating matrix or the second surface-ion diffusion enhancement coating is ion-conductive.

In embodiments of the present disclosure, the first SIDE coating is a thin film comprising or consisting of a solid electrolyte material such as an inorganic electrolyte material or a polymer electrolyte. In other embodiments of the present disclosure, the first SIDE coating is a thin film comprising or consisting of a dielectric material and/or an electrically conductive material suitable to enhance the ionic surface diffusion. The first SIDE coating may be a continuous layer or a discontinuous layer.

Further, in embodiments of the disclosure, the electrically conductive material is one of a metal, a metallic compound, carbon or a conductive oxide.

Further in embodiments of the disclosure, the thin film (first SIDE coating) is discontinuous and the first SIDE coating further comprises a conduction salt to enhance the ionic conductivity.

In embodiments of the disclosure, the electrically insulating matrix is a non-ion-conductive matrix. The non-ionic-conductive matrix comprises one of a microporous, a nanoporous or a mesoporous alumina, silica, hydrated aluminosilicates (zeolites), Metal Organic Frameworks (MOFs) or Anodized Aluminum Oxide (AAO).

In embodiments of the disclosure wherein the electrically insulating matrix is a non-ion-conductive matrix, the second SIDE coating is a thin film comprising or consisting of a solid electrolyte material such as an inorganic electrolyte material or a polymer electrolyte.

Further, in other embodiments of the disclosure wherein the electrically insulating matrix is a non-ion-conductive matrix, the second SIDE coating comprises or consists of a thin film comprising/consisting of a dielectric material to improve wettability and an ionic compound of an ion to diffuse, such as a Lithium salt.

In alternative embodiments of the disclosure, the electrically insulating matrix is an ion-conductive matrix.

The ion-conductive matrix may for example comprise a Lithium compound, a Lithium salt or Lithium oxide.

In embodiments of the disclosure wherein the electrically insulating matrix is an ion-conductive matrix, the second SIDE coating is a thin film comprising or consisting of a dielectric material suitable to enhance the ionic surface diffusion.

The functional battery material or active electrode material is either an ion-insertion material or an alloying material.

In specific embodiments of the disclosure, the active electrode material is selected from the group consisting of LiCoO₂, MnO₂, LiMn₂O₄, LiFePO₄, LiNiO₂, Li₂FePO₄F, TiS₂, WO₃—V₂O₅, In₂Se₃, TiSₓO_{y}, V₂O₅—TeO₂, V₂O₅, MOₓ, Liₓ(Mn_{y}Ni_{1-y})₂₋ₓO₂ or Li—V₂O₅, Si, SiSn, Ge, GeSn, Sn, and SnCu.

In embodiments of the disclosure, the solid-state battery further comprises two metal collectors, each of them in contact with an active electrode and one of the metal collectors overlying a substrate.

The substrate can be a planar substrate or can present topography (e.g. 3D structures such as pillars). Further, the substrate can for example comprise or can be made of a semiconductor material, a metal, carbon nanosheets (CNS, which is a collection of vertically aligned graphitic sheets) or a plastic foil.

In a second aspect, the disclosure is related to a method for manufacturing a solid-state battery cell comprising an anode, a cathode and a solid electrolyte matrix, the method comprising the following steps: providing a current collector on a substrate; depositing one of the anode and the cathode which comprises an active electrode material (functional battery material) having pores; forming a first surface-ion diffusion enhancement (SIDE) coating on an inner surface of the pores of the active electrode material; forming the solid electrolyte matrix which comprises an electrically insulating matrix having pores or passages; and forming a second surface-ion diffusion enhancement (SIDE) coating on an inner surface of the pores or the passages of the electrically insulating matrix.

In some embodiments, the method of the disclosure includes forming the first SIDE coating and forming at least a part of the second SIDE coating simultaneously, in one process step, after forming the solid electrolyte matrix.

In embodiments of the disclosure, forming the first SIDE coating and forming the second SIDE coating is performed by ALD (Atomic Layer Deposition) or MLD (Molecular Layer Deposition).

In embodiments of the disclosure, forming the electrically insulating matrix, which comprises low-κ materials, is performed by CVD (Chemical Vapor Deposition) or spin-on deposition techniques.

In a third aspect, the disclosure is related to a surface ion-diffusion enhancement (SIDE) coating layer for a solid-state battery cell, suitable to be coated on a porous functional battery material (active electrode material) or on a porous solid electrolyte matrix, on an inner surface of the pores thereof, the coating comprising a thin film made of at least one layer of a dielectric material, an electrically conductive material or a solid electrolyte material.

Further, the electrically conductive material of the SIDE coating layer is one of a metal, a metallic compound, or a conductive oxide.

Certain objects and advantages of various inventive aspects have been described herein above. Of course, it is to be understood that not necessarily all such objects or advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other objects or advantages as may be taught or suggested herein. Further, it is understood that this summary is merely an example and is not intended to limit the scope of the disclosure. The disclosure, both as to organization and method of operation, together with features and advantages thereof, may best be understood by reference to the following detailed description when read in conjunction with the accompanying drawings.

### BRIEF DESCRIPTION OF THE DRAWINGS

All drawings are intended to illustrate some aspects and embodiments of the present disclosure. The drawings described are only schematic and are non-limiting.

FIG. 1 shows a schematic cross section of a thin film battery cell.

FIG. 2 illustrates schematically the delaminating interfaces and the cracked layers during the cycling of a thin film battery.

FIG. 3 shows schematically the solid-state porous thin film battery according to the disclosure.

FIG. 4a shows a porous layer of electrochemically synthesized γ-MnO₂, which is formed conformal on a 3D substrate (Si pillars) according to the method of the disclosure.

FIG. 4b shows a porous MnO₂ layer formed on a planar substrate according to the method of the disclosure.

Any reference signs in the claims shall not be construed as limiting the scope of the present disclosure.

In the different drawings, the same reference signs refer to the same or analogous elements.

### DETAILED DESCRIPTION OF ILLUSTRATIVE EMBODIMENTS

Generally, the present disclosure may provide a thin film solid-state battery that has improved performance with respect to the state of the art solid-state batteries, such as an improved accessible or effective battery capacity, an improved battery power, an improved battery life time, and an improved behavior at mechanical deformation.

The present disclosure may also provide a coating layer suitable for a thin film solid-state battery that improves at least one of the effective battery capacity, battery power and/or the battery life time.

Further, the present disclosure may provide a method of manufacturing a thin film solid-state battery having an improved effective battery capacity and/or an improved battery life time and/or an improved behavior at mechanical deformation.

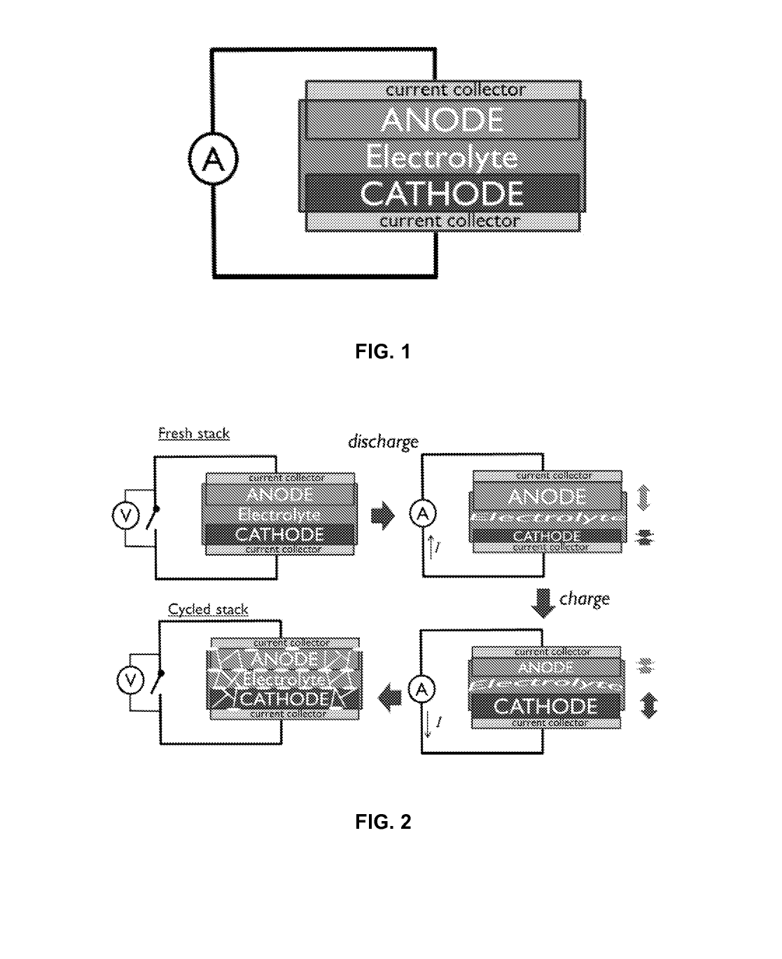

A thin film solid-state battery cell comprises in general a cathode, an anode, and an electrolyte sandwiched in between two current collectors as shown schematically in FIG. 1. The cell is constructed sequentially on a substrate.

Nowadays, lithium ion transfer cells dominate development in this sector, and the commercial interest in lithium ion transfer systems grows continuously. This is because the Li⁺ ion transfer battery is a very promising system for satisfying the demand for high specific energy and high power batteries for portable applications, especially for cellular phones and portable computers.

In thin film Li-ion batteries (LiB), both electrodes are capable of reversible lithium insertion. Because of the difference in chemical potentials of lithium in the two electrodes, the transfer of lithium ions from the anode through the electrolyte into the cathode (discharge) delivers energy, whereas the reverse lithium transfer (charge) consumes energy. When the battery is being discharged, the lithium ions in the anode material (negative electrode) migrate to the cathode material (positive electrode), and a discharging current flows. When the battery is being charged, the lithium ions move into the opposite direction to their original positions in the materials and a charging current flows. A thin film battery is fabricated by forming sequentially its components, thereby producing multi-layered thin films by suitable techniques.

The active electrode material that is the anode in discharge (negative electrode) becomes the cathode (negative electrode) when charging the battery. Herein, anode material and cathode material mean the materials or electrodes that are the anodes and, respectively, the cathodes during battery operation (i.e. during discharge). The labeling in FIG. 2 follows the same convention. Through the disclosure, when referred to “anode material” it is meant the negative electrode material and when referred to “cathode material” it is meant the positive electrode material.

Although the thin film solid-state batteries have multiple advantages with respect to the older technologies, there are still issues that have to be addressed as further discussed.

For example, the thin film stack is a rigid structure with a far from ideal behavior with respect to mechanical deformation. The stress on the electrolyte is large as the negative and positive electrodes at each side of the electrolyte respectively shrink and expand during battery operation, and again expand and shrink during battery charge. For the Li ion battery, for example, upon discharge, the negative electrode (anode) takes up Li⁺ ions and swells, whereas the positive electrode (cathode) gives off Li⁺ ions and shrinks. Upon charging of the battery, the opposite process takes place. This continues shrinkage and swelling causes the delaminating of the layers at the interfaces and, in severe cases, embrittlement of the films themselves. As a consequence, ionic contact between electrode and electrolyte (and electrical contact between the pieces of the embrittled electrode) is lost and the battery fails.

Planar thin film batteries can still work when films are made thick enough to disperse the strain, and by limiting the level/percentage of charge capacity used. However, for 3D thin film batteries, the films are generally thinner and the strain is even more prominent in the curved structures and in the corners. This is a major reason why solid-state 3D thin film batteries are underperforming Attempts were made to use a polymer-gel (sandwiched between anode and cathode thin film layers) as a “plastic” interlayer to take up the mechanical deformation. However, this latter attempt disrupts the all solid-state concept, since a polymer-gel battery is manufactured with a solvent impregnated polymer that brings back with itself the known drawbacks of wet batteries.

FIG. 2 illustrates schematically the delaminating interfaces and the cracked layers during the cycling of a thin film battery.

Another important parameter for solid-state batteries is the accessible or effective battery capacity at a certain current (C-rate). This is determined by the thickness of the active electrode material as the charge/discharge rate is determined by the transport (diffusion and migration) of Li⁺ ions in the solid material.

For solid-state batteries having an active electrode made of powders, which have a large surface to volume ratio, the Li⁺ ions can diffuse in the active electrode material from all around, at least where contact with the electrolyte is provided. For thin film batteries, only the film surface (at the interface with the electrolyte film) is available for Li⁺ insertion or extraction in or out of the active electrode layer.

To improve access to Li⁺ ions, the active material can be made porous. Then, the pores can be easily accessed by the liquid solvent in wet batteries, but, up to now, this is impossible for solid-state batteries and polymer-gel batteries.

In its different aspects, the present disclosure relates to using porous materials for at least one of the active electrodes and for the solid electrolyte. Porous materials have a larger plastic deformation window and are able to take the strain during the charge/discharge cycling. In general, the porous materials are known to have high inner or internal surface area values. However, the present disclosure does not limit itself to this aspect.

In its different aspects the present disclosure further discloses boosting the ion mobility in a solid-state electrolyte and/or in a solid-state insertion electrode by using the higher mobility of ions at interfaces, e.g. at an interface between an ionic compound and an inert layer, compared to the bulk. As described in detail below, the porous structure of the active electrodes and/or the solid electrolyte matrix are coated with a surface-ion diffusion enhancing coating, resulting in a high contribution of interfacial ion conduction to the total ion conduction through the materials. Thereby the ion conductivity is significantly increased, both in the porous electrodes and in the porous electrolytes.

In different embodiments of the present disclosure, a large surface to volume ratio between the solid electrolyte and an active electrode is achieved by introducing an ion-conductive compound as a solid electrolyte into the porous matrix of the active electrode. At least one of the active electrodes is porous.

The solid electrolyte matrix can be made of an electrically insulating material such as an inorganic porous material or a polymer matrix that can host ion-conductive compounds such as salts. The ion-conductive compounds may be, for example, introduced by impregnation. The impregnation step may coat the solid electrolyte matrix and the solid porous electrode in one and the same step, or it can consist of multiple steps.

As illustrated by different embodiments, the solid-state battery of the disclosure comprises one of the coated porous electrodes (a or b) and one of the coated porous electrically insulating matrix (c or d) below:

(a) a porous electrode with a non-ion-conductive coating (such as a dielectric, metallic compound or polymer) inside the pores or openings to enhance interface diffusion;

(b) a porous electrode with an ion-conductive coating inside the pores or openings to promote ionic diffusion by interface diffusion;

(c) a porous electrically insulating matrix, which is also ionically insulating, in the form of a porous film (e.g. Alumina, silica) coated with a thin, continuous ion-conductive coating (although it may have a very poor bulk ion conductivity) which has enhanced interface conduction. The porous electrically and ionically insulating matrix in the form of a porous film is therefore different from a composite electrolyte, which is usually a powder; and

(d) a porous electrically insulating matrix, which is ionically conductive (although it may have poor bulk ion conductivity, such as Li₃PO₄) coated with a thin, preferably continuous dielectric film.

The present disclosure will be described with respect to particular embodiments and with reference to certain drawings but the disclosure is not limited thereto. The drawings described are only schematic and are non-limiting. In the drawings, the size of some of the elements may be exaggerated and not drawn on scale for illustrative purposes. The dimensions and the relative dimensions do not correspond to actual reductions to practice of the disclosure.

Furthermore, the terms first, second and the like in the description, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Moreover, the terms top, under and the like in the description are used for descriptive purposes and not necessarily for describing relative positions. It is to be understood that the terms so used are interchangeable under appropriate circumstances and that the embodiments of the disclosure described herein are capable of operation in other orientations than described or illustrated herein.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

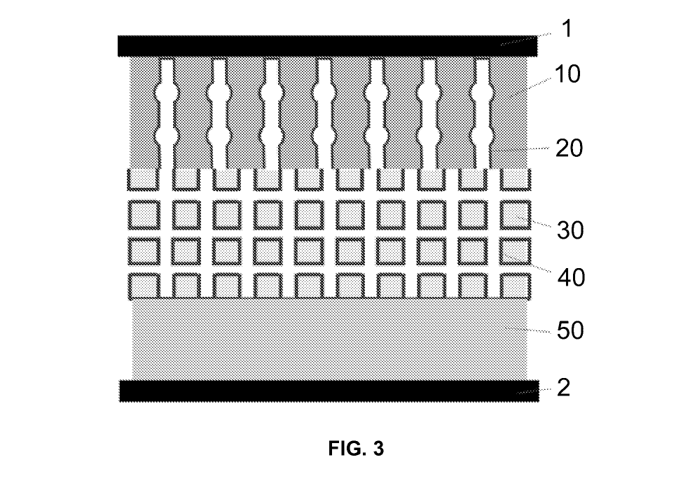

A first aspect of the disclosure relates to a solid-state battery cell (herein further references from FIG. 3 are used) comprising an anode, a cathode and a solid electrolyte matrix, wherein at least the anode or the cathode comprises an active electrode material (functional battery material) 10 having pores and wherein an inner surface of the pores of the active electrode material is coated with a first surface ion-diffusion enhancement (SIDE) coating 20; and wherein the solid electrolyte matrix comprises an electrically insulating matrix 30, the electrically insulating matrix having pores or passages wherein an inner surface of the pores or the passages of the electrically insulating matrix is coated with a second surface ion-diffusion enhancement (SIDE) coating 40. Either the electrically insulating matrix 30 or the second surface-ion diffusion enhancement coating 40 is ion-conductive.

As is disclosed further in some embodiments of the disclosure, the first SIDE coating 20 and at least a component of the second SIDE coating 40 may have the same composition. Advantageously, the first SIDE coating 20 and at least a component of the second SIDE coating 40 (e.g. a thin film which is part of the second SIDE coating) can be applied in one process step on a stack of layers comprising the active electrode material 10 and the electrically insulating matrix 30 as detailed further in the second aspect of the disclosure.

Alternatively, the first SIDE coating 20 and the second SIDE coating 40 can have a different composition. The different options for SIDE coatings are discussed in detail below.

Throughout the description when reference is made to a functional battery material 10 or an active electrode material 10, 50, a material is meant wherein the actual electrochemical process takes place.

The functionality of the “surface ion-diffusion enhancement” (SIDE) coating is based on the effect that ion diffusion is much faster at an interface between an ionic compound (e.g., a salt or an oxide containing the ion which needs to diffuse) and a second material (typically an inert compound or a dielectric) than through the bulk of the ionic compound. In those cases where electrical conduction is desired, the inert compound can be a metallic compound. The inert compound can also be another ionic compound as long as they do not intermix and create the needed double layer that provides the enhanced ion movement at the interface.

Providing a large interfacial area leads to a large surface diffusion component and thus a lower total conductivity. The present disclosure exploits this phenomenon and applies it to the active electrode materials. Further, by coating the functional battery material with the first SIDE coating, an intrinsic ionic conductor or electrolyte channel is present on the electrode surface without the need for introducing an electrolyte.

The functional battery material is an ion-insertion material or an alloying material. In the ion insertion (e.g. Li-insertion) process, known also as ion intercalation, ions (e.g. Li) are inserted in a crystalline lattice. Alternatively, the functional battery material can be an alloying material, such as a Li—Si-alloy or a Li—Sn-alloy. For a Li battery (LiB) the negative electrode (anode during battery operation, cathode during battery charging, herein further referred as anode) comprises Li metal, graphite, silicon, germanium, tin (Sn), Sn-oxides, Sn-nitrides, Sn-oxinitrides, TiO₂, Li₄Ti₅O₁₂, LiV₂O₅ or V₂O₅. For example, for LiB, Li₄Ti₅O₁₂ can be used as the negative electrode. As this spinel structure has a negligible volume change during charge/discharge, it can be used in non-porous form.

The positive electrode (cathode during battery operation, anode during battery charging, herein further referred as cathode) may comprise LiCoO₂, MnO₂, LiMn₂O₄, LiFePO₄, LiNiO₂, Li₂FePO₄F, TiS₂, WO₃—V₂O₅, In₂Se₃, TiSₓO_{y}, V₂O₅—TeO₂, V₂O₅, MOₓ, Liₓ(Mn_{y}Ni_{1-y})₂₋ₓO₂ or Li—V₂O₅. An example of porous functional battery material is electrochemically deposited (EMD) MnO₂ which can be transformed to LiMn₂O₄ spinel.

Usually, lithium metal used for the anode is prepared by vacuum thermal vapor deposition (VD). Solid electrolytes and the cathode or sometimes the anode materials of oxides may be prepared by various sputtering techniques such as RF-assisted sputtering or RF magnetron sputtering. In some examples chemical vapor deposition (CVD), chemical solution deposition (CSD), or electrostatic spray deposition (ESD) are used. Also, plasma/laser assisted deposition techniques or sol-gel methods can be used, especially for cathode materials.

In embodiments of the disclosure, the first SIDE coating applied on the internal surface of the pores of the functional battery material (active electrode material) is a thin film that comprises a solid electrolyte material such as an inorganic electrolyte material or a polymer electrolyte. Preferably, the first SIDE coating is a thin film, which consists of a solid electrolyte material such as an inorganic electrolyte material or a polymer electrolyte.

Non-limitative examples of inorganic electrolyte materials also referred to as a thin solid electrolyte are LiTaO₃, LiAl₂O₄, and Li₂SiO₃. Different insulating polymers can be used as host for salts (e.g. Li-ion salts) and form in combination therewith a polymer electrolyte. Illustrative examples of insulating polymers used as hosts are Poly-ethylene oxide (PEO), poly-propylene oxide (PPO), Poly-phenylene oxide (PPO), polyoxyphenylenes, (POP), Poly(methyl methacralate) PMMA, Poly(acrylonitrile) (PAN) or Poly(ethylene glycol) diacrylate (PEGDA). In an illustrative example of a preparation method for such a polymer electrolyte, the insulating polymers are treated with a Li-salt in a solvent like e.g. acetonitrile and subsequently dried.

In other embodiments of the disclosure, the first SIDE coating applied on the internal surface of the pores of the functional battery material (active electrode material) is a thin film comprising a dielectric material or an electrically conductive material suitable to enhance the ionic surface diffusion. Preferably, the first SIDE coating is a thin film, which consists of a dielectric material or an electrically conductive material suitable to enhance the ionic surface diffusion.

In specific embodiments, the first SIDE coating is a thin film, which comprises a dielectric material and an electrically conductive material, as illustrated under the paragraph about nanolaminates as first SIDE coating.

The thin film used as first SIDE coating can be continuous or discontinuous. In the latter case the first SIDE coating may further comprise a conduction salt to enhance the ionic conductivity. The discontinuities in the thin film allow access to the active electrode material and to the electrolyte layer on top. An illustrative but non-limitative example of a conduction salt is a Li salt.

In embodiments of the disclosure, the electrically conductive material acting as the first SIDE coating is one of a metal, a metallic compound, carbon or a conductive oxide. Illustrative but non-limitative examples of an electrically conductive material are TiN, TaN, C, Ru, Pt or conductive oxides such as SnO₂, tin-doped indium oxide (ITO) and RuO₂. Embodiments of the disclosure wherein the first SIDE coating consists of an electrically conductive material may have the additional advantage that next to the ionic conductance also electrical conductance is improved.

In other embodiments of the disclosure, the dielectric material acting as the first SIDE coating can be an oxide such Al₂O₃, SiO₂, Ta₂O₃, HfO₂, SrO₂, SrSiO₄, MgO or any combinations or mixtures thereof An example of a combination thereof is a nanolaminate coating made of Al₂O₃ and MgO. Many of these oxides, which are suitable to function as a first SIDE coating, are known as high-κ dielectrics used in CMOS and RRAM applications. The term high-κ dielectric refers to a material with a dielectric constant κ higher than that of silicon dioxide. Alternatively, the dielectric material acting as the first SIDE coating can be a polymer dielectric.

In yet other embodiments of the disclosure, the first SIDE coating can be a nanolaminate comprising at least two selected from the group consisting of a dielectric, a metal, a polymer and a Li-compound. Non-limitative examples of a Li-compounds suitable to be used in such nanolaminates are Li₂O, Li₂Co₃, Li₃PO₄, etc.

In different embodiments of the disclosure the solid electrolyte matrix comprises an electrically insulating matrix 30. In specific embodiments the electrically insulating matrix is a non-ion-conductive matrix. Examples of a non-ion-conductive matrix are microporous, nanoporous or mesoporous alumina, silica, hydrated aluminosilicates (zeolites), Metal Organic Frameworks (MOFs) and Anodized Aluminum Oxide (AAO).

In specific embodiments the non-ionic-conductive matrix may comprise low-k materials formed by CVD or spin-on techniques.

In the embodiments wherein the electrically insulating matrix is a non-ion-conductive matrix, the second SIDE coating 40 comprises a thin film comprising a solid electrolyte material such as an inorganic electrolyte material or a polymer electrolyte as described above in relation to the first SIDE coating. Preferably in this embodiment, the second SIDE coating comprises a thin film consisting of a solid electrolyte material such as an inorganic electrolyte material or a polymer electrolyte as described above in relation to the first SIDE coating.

The inorganic electrolyte or the polymer electrolyte can act both as first

SIDE coating (for the active electrode material) and as second SIDE coating (for the non-ion-conductive matrix). The polymer electrolytes give elasticity to the stack of layers that form the solid-state battery cell.

In other embodiments of the disclosure the electrically insulating matrix 30 is an ion-conductive matrix. Illustrative and non-limitative examples of an ion-conductive matrix are lithium salts such as LiPF₆, LiBF₄ or LiClO₄ or lithium oxides.

In the embodiments of the disclosure wherein the electrically insulating matrix 30 is an ion-conductive matrix, the second SIDE coating 40 comprises a thin film comprising a dielectric material suitable to enhance the ionic surface diffusion. Preferably in these embodiments, the second SIDE coating 40 comprises a thin film consisting of a dielectric material suitable to enhance the ionic surface diffusion. The dielectric materials suitable to enhance the ionic surface diffusion were disclosed above in relation to the first SIDE coating. The dielectric material can act both as first SIDE coating (for the active electrode material) and as second SIDE coating (for the ion-conductive matrix). In an example the ion-conductive matrix is a porous Li₃PO₄ and the second SIDE coating is made of Al₂O₃.

Alternatively, in the embodiments wherein the electrically insulating matrix is a non-ion-conductive matrix, the second SIDE coating may comprise a dielectric material as a first layer having the role to improve the wetting and to introduce surface acidity on the surface of the non-ion-conductive matrix. Then, an ionic compound of the ion to diffuse (e.g. a Li-salt for Li-battery) is coated on top of the dielectric material.

The solid-state battery cell of the disclosure may further comprise two metal collectors 1, 2, each of them in contact with an active electrode material 10, 50 and one of them overlying a substrate. In specific embodiments the positive electrode current collector comprises TiN, Pt, Al or C and the negative electrode current collector comprises TiN or Cu. The metal collector may have a planar configuration or a 3D configuration, i.e. a non-planar surface presenting topography.

In various embodiments of the disclosure the substrate is a semiconductor material such as a group IV semiconductor material, a metal (e.g., metal foils), carbon nanosheets or a plastic foil. In the particular case wherein the substrate is made of silicon, a barrier of TiN is formed in between the collector and the silicon substrate.

Further, the solid-state battery cell of the disclosure can be part of an assembly comprising at least one electronic device co-integrated (manufactured in an integrated process flow) or co-assembled (assembled as separate elements each of them having its own process flow) on a common substrate with the solid-state battery cell.

The second aspect of the present disclosure teaches a method for manufacturing a solid-state battery cell comprising an anode, a cathode and a solid electrolyte matrix, the method comprising the following steps: providing a current collector 1, 2 on a substrate; depositing one of the anode or the cathode which comprises a functional battery material 10 having pores; forming a first surface-ion diffusion enhancement (SIDE) coating 20 on an internal surface of the pores of the functional battery material 10, forming the solid electrolyte matrix which comprises an electrically insulating matrix 30 having pores or passages; and forming a second surface-ion second diffusion enhancement (SIDE) coating 40 on the internal surface of the pores or the passages of the electrically insulating matrix.

In the embodiments wherein a first SIDE coating and at least part (a component) of the second SIDE coating are the same or have substantially the same composition, forming/depositing the first SIDE coating can be performed simultaneously (in one process step) with forming/depositing the second SIDE coating, after forming the electrically insulating matrix.

Forming the first and/or the second SIDE coating can be performed by Atomic Layer Deposition (ALD) or Molecular Layer Deposition (MLD), which are both conformal techniques which can reach inside the small pores/passages and which are also surface limited deposition techniques. Alternatively the deposition can be done by electrochemical deposition, chemical solution deposition or precipitation reactions. In the specific example wherein MnO₂ is the functional battery material, a thin polymer (thickness of about 15 nm or smaller) may be formed by electrochemical polymerization (anodic deposition of PPO from phenol solutions).

The third aspect of the present disclosure relates to a surface ion-diffusion enhancement (SIDE) coating for a solid-state battery cell, suitable to be coated on a porous functional battery material or on a porous solid electrolyte matrix, on an inner surface of the pores thereof, the SIDE coating comprising a thin film made of at least one layer of dielectric material, an electrically conductive material, a solid electrolyte material or a combination thereof. The combination thereof can be a multilayer deposited sequentially on the porous functional battery material and/or on the porous solid electrolyte matrix.

The dielectrics, electrically conductive materials and solid electrolyte materials as well as the combinations thereof with their respective suitability/functionality as SIDE coatings under the third aspect of the disclosure are identical to those disclosed under the first and the second aspect of the disclosure and therefore not repeated.

An exemplary process flow for producing a solid-state thin film battery cell according to embodiments of the disclosure will be described with reference to FIG. 3.

First a current collector 1 is formed on a substrate (not shown). The substrate can be a Si wafer whereon a layer of SiO₂ (not shown) was formed prior to forming the current collector. In an example the current collector is a thin film formed by physical vapor deposition (PVD) which comprises C-coated TiN and has a thickness of about 30 nm. The C-coating was performed by CVD, the TiN deposition by PVD or ALD. Alternatively the current collector can be made of Pt-coated TiN. On the current collector, a thin film of a porous active electrode 10 is formed as shown in FIG. 3. The porous active electrode is formed by electrochemical deposition (ECD) of MnO₂, which may be subsequently transformed to LiMn₂O₄ spinel by electrochemical lithiation either immediately post-deposition, or later in the process flow. Preferably the lithiation can be performed after forming the first SIDE coating 20.

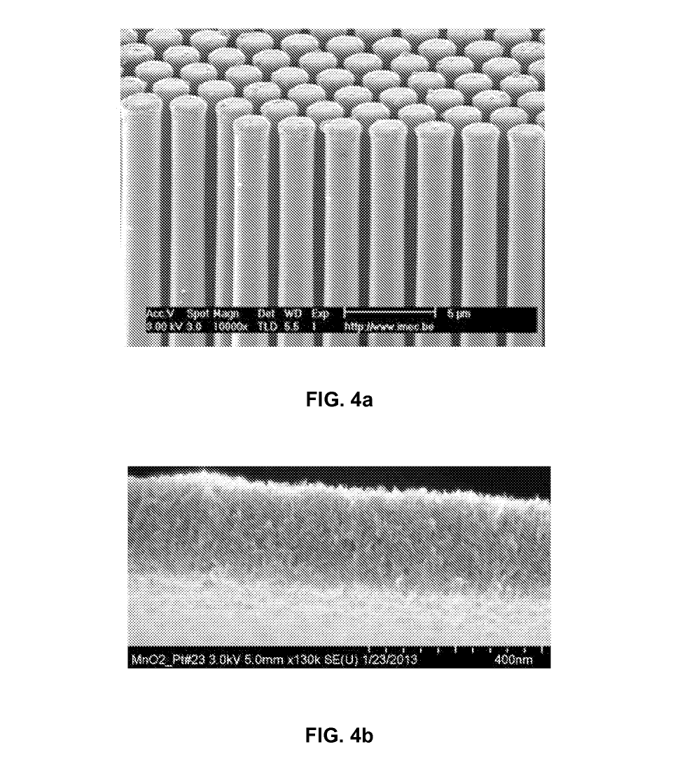

FIG. 4a illustrates a porous layer of electrochemically synthesized γ-MnO₂ formed conformally on Si pillars as illustration of a 3D substrate. FIG. 4b shows the porous MnO₂ layer formed on a planar substrate. In this specific example, 200 nm porous MnO₂ was formed continuous and conformal. The MnO₂ layer has a porosity of 50 to 70%.

As shown in FIG. 3 a thin coating 20, also referred to as first SIDE coating, is deposited inside the pores of the active electrode material 10. In an example, the first SIDE coating is an Al₂O₃ layer deposited by ALD. The thickness of the first SIDE coating is between 0.2 nm and 5 nm, more preferably between 0.5 nm and 1 nm.

In an alternative embodiment, a PPO polymer coating is formed in the pores by anodization of phenol in acetonitrile solution.

Further, an electrically insulating matrix 30 is formed on the coated active electrode 10. In particular embodiments the electrically insulating matrix is an non-ion-conductive matrix with a porous structure and can be formed by e.g. chemical vapor deposition (CVD) or spin-on. The porous non-ion-conductive matrix can be made of low-κ materials/dielectrics and has a thickness of about 60-90 nm. In semiconductor manufacturing, a low-κ dielectric is a material with a small dielectric constant relative to silicon dioxide. In an alternative example about 100 nm anodized aluminum oxide (AAO) with a pore size of about 8 nm was used.

In a next step the functionalization of the electrically insulating matrix 30 is performed by deposition of a second SIDE coating 40 as shown in FIG. 3. In different embodiments the first SIDE coating 20 and the second SIDE coating 40 may have the same composition and may be formed at the same time, in one process step, after the electrically insulating matrix is formed.

In some embodiments, an ALD alumina layer is deposited first inside the pores of the low-κ material (acting as electrically insulating matrix) to thereby improve the wetting and the surface acidity and to enhance the subsequent functionalization with Li-salt. A conformal Al₂O₃ layer of about 0.5 nm is deposited in a particular example.

Next, impregnation in Li-salt solution (also referred herein as a conduction salt) is performed in order to form the SIDE coating 40 and 20 with Li-salt. Examples of such Li-salts are LiPO3, Li₃PO₄, LiH₂PO₄, Li₂HPO₄, Li₂CO₃, LiHCO₃, Li₂O, LiOH, LiI, and LiClO₄, which are dissolved in solvents such as water, isopropyl-alcohol (IPA) or acetonitrile.

When the electrically insulating matrix 30 is made of AAO, the coating with alumina can be omitted and direct functionalization of the AAO is performed.

Following the impregnation, an anneal is performed of the impregnated structure at temperature between about 70° C. to about 250° C. for 6 hours to 48 hours.

In a next step the second active electrode material 50 (FIG. 3) is formed by e.g. PVD or CVD. The second electrode material has a thickness up to 1 micron. In specific embodiments a TiO₂ layer of about 30 nm thickness is first deposited by ALD, and subsequent a Li₄Ti₅O₁₂ layer of about 200 nm-500 nm thickness is deposited by RF-PVD.

In a further step, the second current collector 2 is formed by physical vapor deposition or an alternative deposition technique. The second current collector may for example comprise Ti, TiN, Cu and/or Al.

The foregoing description details certain embodiments of the disclosure. It will be appreciated, however, that no matter how detailed the foregoing appears in text, the disclosure may be practiced in many ways. It should be noted that the use of particular terminology when describing certain features or aspects of the disclosure should not be taken to imply that the terminology is being re-defined herein to be restricted to including any specific characteristics of the features or aspects of the disclosure with which that terminology is associated.

While the above detailed description has shown, described, and pointed out novel features of the disclosure as applied to various embodiments, it will be understood that various omissions, substitutions, and changes in the form and details of the device or process illustrated may be made by those skilled in the technology without departing from the disclosure.

1. A solid-state battery cell comprising:
an anode, a cathode, and a solid electrolyte matrix,
wherein at least one of the anode or the cathode comprises an active electrode material having pores,
wherein an inner surface of the pores is coated with a first surface-ion diffusion enhancement coating,
wherein the solid electrolyte matrix comprises an electrically insulating matrix,
wherein the electrically insulating matrix has pores or passages,
wherein an inner surface of the pores or the passages is coated with a second surface-ion diffusion enhancement coating, and
wherein at least one of the electrically insulating matrix or the second surface ion-diffusion enhancement coating is ion-conductive.

2. The solid-state battery cell according to claim 1, wherein the first surface-ion diffusion enhancement coating is a thin film comprising a solid electrolyte material.

3. The solid-state battery cell according to claim 1, wherein the first surface-ion diffusion enhancement coating is a thin film comprising at least one of a dielectric material or an electrically conductive material suitable to enhance the ionic surface diffusion.

4. The solid-state battery cell according to claim 3, wherein the electrically conductive material is selected from the group consisting of a metal, a metallic compound, and a conductive oxide.

5. The solid-state battery cell according claim 1, wherein the electrically insulating matrix is a non-ion-conductive matrix.

6. The solid-state battery cell according to claim 5, wherein the non-ion-conductive matrix comprises one or more of a microporous alumina, a nanoporous alumina, a mesoporous alumina, silica, hydrated aluminosilicates (zeolites), Metal Organic Frameworks (MOFs), or Anodized Aluminum Oxide (AAO).

7. The solid-state battery cell according claim 5, wherein the second surface-ion diffusion enhancement coating is a thin film comprising a solid electrolyte material.

8. The solid-state battery cell according to claim 5, wherein the second surface-ion diffusion enhancement coating comprises a thin film comprising a dielectric material to improve wettability and an ionic compound of an ion to diffuse.

9. The solid-state battery cell according to claim 1, wherein the electrically insulating matrix is as ion-conductive matrix.

10. The solid-state battery cell according to claim 9, wherein the ion-conductive matrix comprises a Lithium salt or Lithium oxide.

11. The solid-state battery cell according to claim 9, wherein the second surface-ion diffusion enhancement coating is a thin film comprising a dielectric material suitable to enhance the ionic surface diffusion.

12. A method for manufacturing a solid-state battery cell comprising an anode, a cathode, and a solid electrolyte matrix, the method comprising:
providing a current collector on a substrate;
depositing one of the anode or the cathode, wherein the anode or the cathode comprises an active electrode material having pores;
forming a first surface-ion diffusion enhancement coating on an inner surface of the pores of the active electrode material;
forming the solid electrolyte matrix, wherein the solid electrolyte matrix comprises an electrically insulating matrix having pores or passages; and
forming a second surface-ion diffusion enhancement coating on an inner surface of the pores or on the passages of the electrically insulating matrix.

13. The method according to claim 12, wherein the first surface-ion diffusion enhancement coating and least a part of the second surface-ion diffusion enhancement coating are deposited simultaneously, in one process step, after forming the solid electrolyte matrix.

14. The method according to claim 12, wherein forming the first surface-ion diffusion enhancement coating and forming the second surface-ion diffusion enhancement coating is performed by Atomic Layer Deposition or Molecular Layer Deposition.

15. A surface ion-diffusion enhancement coating layer for a solid-state battery cell, suitable to be coated on a porous active electrode material or on a porous solid electrolyte matrix, on an inner surface of the pores thereof, comprising a thin film made of at least one layer of a dielectric material, an electrically conductive material, or a solid electrolyte material.
